(19) United States
(12) Patent Application Publication
(10) Pub. No.: US 2023/0237539 A1
(43) Pub. Date: Jul. 27, 2023

(54) METHODS AND SYSTEMS FOR GIVING

(71) Applicants: Les Daggs, Southfield, MI (US); Taja Sevelle-Daggs, Southfield, MI (US)

(72) Inventors: Les Daggs, Southfield, MI (US); Taja Sevelle-Daggs, Southfield, MI (US)

(21) Appl. No.: 18/155,182

(22) Filed: Jan. 17, 2023

Related U.S. Application Data
(60) Provisional application No. 63/299,741, filed on Jan. 14, 2022.
(60) Provisional application No. 63/317,310, filed on Mar. 7, 2022.
(60) Provisional application No. 63/324,756, filed on Mar. 29, 2022.
(60) Provisional application No. 63/365,636, filed on Jun. 1, 2022.

(51) Int. Cl. G06Q 30/0279; G07F 17/32; G06Q 20/22

(52) U.S. Cl. CPC G06Q 30/0279; G07F 17/329; G07F 17/3244; G06Q 20/22

(57) ABSTRACT

A method of processing a giving transaction is disclosed. The method includes receiving, from multiple users, enrollment information including (for each user): a postal code and an indication that the user has entered an upcoming game of chance associated with a monetary prize. The method further includes registering the users (and corresponding enrollment information) and, in response to a registered user winning a prize share consists of some or all of the monetary prize, identifying a winning postal code based on the enrollment information of the registered user that won the prize share. The method further includes distributing a portion of the prize share to the registered user that won the prize share and distributing a remaining portion of the prize share by distributing a first portion to the registered users having an associated postal code that matches the winning postal code and distributing a second portion to other users.

### CROSS-REFERENCE AND CLAIM OF PRIORITY

This patent application claims priority to U.S. Provisional Patent Application No. 63/299,741 filed Jan. 14, 2022, U.S. Provisional Patent Application No. 63/317,310, filed Mar. 7, 2022, U.S. Provisional Patent Application No. 63/324,756, filed Mar. 29, 2022, and U.S. Provisional Patent Application No. 63/365,636, filed Jun. 8, 2022. The disclosures of these applications are hereby incorporated into this document by reference, in their entirety.

### BACKGROUND

A lottery generally involves the drawing of numbers at random for a prize. Lotteries come in many formats. For example, the prize can be a fixed amount of cash or goods. Commonly, customers purchase lottery tickets at dedicated point-of-sale terminals located at retail stores or similar establishments. A point-of-sale terminal communicates with a central lottery server to exchange information associated with a given lottery transaction. For each transaction, the customers can select their own numbers or have a machine randomly select numbers for them. The point-of-sale terminal then transmits the selected numbers to the central lottery server to be stored and receives directions to print the associated lottery ticket locally. If the numbers that are drawn match the selected numbers, the player may win a jackpot.

Lottery winnings (also known as jackpots) may be paid in a lump sum or an annuity. However, jackpots have historically been paid to one or just a few winners, with the only other potential beneficiary being the organization that operates the lottery (e.g., the state) and the business operating the point-of-sale. The community at large does not benefit. The high value of lottery jackpots may also pose issues for the winners. For instance, some lotteries have jackpots that range from tens of millions of dollars to over a billion dollars, a fraction of which would be life changing for the vast majority of people. Some people hire a third party to cash the lottery ticket for them, or hire an attorney to set up a blind trust for them so they can claim their prize and remain anonymous. This is done so that winners can avoid scams, jealousy, and other disadvantages that can come with winning a lottery jackpot. To mitigate these issues, a system is needed to allow lottery players to automatically include a charitable, giving, or altruistic component to the process of claiming a prize.

This document describes methods and systems that address issues such as those discussed above, and/or other issues.

### SUMMARY

The present disclosure describes embodiments related to transaction processing for giving. The present disclosure also describes embodiments related to a method of distributing lottery winnings across one or more communities, organizations, etc. Other embodiments, additionally or alternatively, distribute lottery winnings across one or more foundational funds, philanthropic endeavors, etc.

In a first set of embodiments, a method is disclosed. The method includes receiving, from multiple users, enrollment information including (for each user): a postal code associated with the user and an indication that the user has entered an upcoming game of chance associated with a monetary prize. The method further includes registering the users (and corresponding enrollment information) and, in response to a registered user winning a prize share which consists of some or all of the monetary prize associated with the game, identifying a winning postal code based on the enrollment information of the registered user that won the prize share. The method further includes distributing a primary portion of the prize share to the registered user that won the prize share and distributing a remaining portion of the prize share. The method includes distributing the remaining portion of the prize share by: distributing a first portion of the remaining portion of the prize share to the registered users having an associated postal code that matches the winning postal code and distributing a second portion of the remaining portion of the prize share to other users.

Implementations of the disclosure may include one or more of the following optional features. In some examples, the upcoming game of chance is a lottery, the indication that the user has entered the upcoming game of chance associated with the monetary prize includes information associated with a ticket for the lottery, and distributing the remaining portion of the prize share includes identifying one or more economically challenged communities based on demographic information and distributing at least a portion of the second portion of the remaining portion to members of the one or more economically challenged communities. In some examples, identifying the one or more economically challenged communities based on the demographic information includes rank-ordering multiple geographical regions based on the demographic information, and distributing the at least a portion of the second portion of the remaining portion to the members of the one or more identified economically challenged communities includes distributing the at least a portion of the second portion of the remaining portion to residents of the multiple geographical regions based on the rank order. In some examples, the demographic information includes mean household income. In at least one embodiment, distributing the at least a portion of the second portion of the remaining portion to the members of the one or more identified economically challenged communities includes transmitting an enrollment request to at least one member of the one or more identified economically challenged communities and, in response to receiving an enrollment reply from the at least one member, distributing the at least a portion of the second portion of the remaining portion to the at least one member.

In some examples, the enrollment information further includes, for at least one user, donation information including: a recipient identifier, recipient contact information, and a donation amount. Distributing the remaining portion of the prize share may include transmitting an enrollment request to the identified recipient using the recipient contact information and, in response to receiving an enrollment reply from the identified recipient, distributing at least a portion of the donation amount to the identified recipient. Distributing the remaining portion of the prize share may include, for one or more candidate recipients, receiving identifying information, including a recipient identifier and recipient contact information. Distributing the remaining portion of the prize share may further include applying a random process to select at least one donee from the one or more candidate recipients and distributing at least a portion of the second portion to the selected donee. In some examples, one or more of the distributions uses a digital payment system. Distributing the remaining portion of the prize share may include distributing some or all of the second portion to one or more recipients using a random selection process.

In other embodiments, a system for processing a giving transaction includes a processor and a memory that stores programming instructions that are configured to cause the processor to receive, from multiple users, enrollment information including, for each user, a postal code associated with the user, and an indication that the user has entered an upcoming game of chance associated with a monetary prize. The programming instructions are further configured to cause the processor to register the users and their corresponding enrollment information. The programming instructions are further configured to, in response to a registered user winning a prize share which consists of some or all of the monetary prize associated with the game, identify a winning postal code based on the enrollment information of the registered user that won the prize share, distribute a primary portion of the prize share to the registered user that won the prize share, and distribute a remaining portion of the prize portion of the prize share by: distributing a first portion of the remaining portion of the prize share to registered users having an associated postal code that matches the winning postal code and distributing a second portion of the remaining portion of the prize share to other users.

Implementations of the disclosure may include one or more of the following optional features. In some examples, the upcoming game of chance is a lottery, the indication that the user has entered the upcoming game of chance associated with the monetary prize includes information associated with a lottery ticket, and the instructions that are configured to cause the processor to distribute the remaining portion of the prize share include instructions that are configured to cause the processor to: identify one or more economically challenged communities based on demographic information and distribute at least a portion of the second portion of the remaining portion to members of the one or more identified economically challenged communities.

The instructions that are configured to cause the processor to identify the one or more economically challenged communities based on the demographic information may include instructions that are configured to cause the processor to rank-order multiple geographical regions based on the demographic information, and the instructions that are configured to cause the processor to distribute the at least a portion of the second portion of the remaining portion to the members of the one or more identified economically challenged communities may include instructions that are configured to cause the processor to distribute the at least a portion of the second portion of the remaining portion to members to residents of the geographical regions based on the rank order.

In some examples, the demographic information includes mean household income.

The instructions that are configured to cause the processor to distribute the at least a portion of the second portion of the remaining portion to the members of the one or more identified economically challenged communities may include instructions that are configured to cause the processor to: transmit an enrollment request to at least one member of the one or more identified economically challenged communities and, in response to receiving an enrollment reply from the at least one member, distribute the at least a portion of the second portion of the remaining portion to the at least one member.

The enrollment information may further include, for at least one user, donation information including: a recipient identifier, recipient contact information, and a donation amount. The instructions that are configured to cause the processor to the remaining portion of the prize share may include instructions that are configured to cause the processor to: transmit an enrollment request to the identified recipient using the recipient contact information and, in response to receiving an enrollment reply from the identified recipient, distribute at least a portion of the donation amount to the identified recipient.

The instructions that are configured to cause the processor to distribute the remaining portion of the prize share may include instructions configured to cause the processor to, for one or more candidate recipients, receive identifying information including a recipient identifier and recipient contact information. The instructions may be further configured to cause the processor to apply a random process to select at least one donee from the one or more candidate recipients and distribute at least a portion of the second portion to the selected donee. One or more of the distributions may use a digital payment system. The instructions that are configured to cause the processor to distribute the remaining portion of the prize share may include instructions that are configured to cause the processor to distribute some or all of the second portion to one or more recipients using a random selection process.

In other embodiments, a system for processing a giving transaction includes a processor and a memory that stores programming instructions that are configured to cause the processor to receive, from user, a donation amount. The programming instructions are further configured to cause the processor to, for one or more candidate recipients, receive identifying information including a recipient identifier and recipient contact information. The programming instructions are further configured to, for each of the one or more candidate recipients, identify a geographic region based on the associated identifying information. The programming instructions are further configured to select at least one donee from the one or more candidate recipients based on one or more factors, including the demographic information or the distance from the residence of the user, and distribute some or all of the donation amount to the selected at least one donee using a digital payment system.

Implementations of the disclosure may include one or more of the following optional features. The instructions that are configured to cause the processor to receive the identifying information may include instructions that are configured to cause the processor to receive the identifying information from an online database of candidate recipients.

The instructions that are configured to cause the processor to distribute some or all of the donation amount to the selected at least one donee may include instructions configured to cause the processor to transmit an enrollment request to the selected at least one donee using the recipient contact information and, in response to receiving an enrollment reply from the selected at least one donee, distribute some or all of the donation amount to the selected at least one donee.

The instructions that are configured to cause the processor to select the at least one donee may include instructions that are configured to cause the processor to apply random weights to the one or more factors to select the at least one donee.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 depicts a flowchart of an example method, in accordance with one embodiment of the present invention;

FIG. 2 shows an illustration of the “Ripple Up” movement, in accordance with one embodiment of the present invention;

FIG. 3 illustrates an example output, in accordance with one embodiment of the present invention;

FIG. 4 illustrates an example input form, in accordance with one embodiment of the present invention;

FIG. 5 depicts a flowchart, in accordance with one embodiment of the present invention;

FIGS. 6A-6T illustrate example user interfaces; and

FIG. 7 illustrates a block diagram of internal hardware included in any of the electronic components of this disclosure, in accordance with one embodiment of the present invention.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such “first” and “second” are used to modify a noun or phrase, such use is simply intended to distinguish one item from another and is not intended to require a sequential order unless specifically stated. The term “about” when used in connection with a numeric value, is intended to include values that are close to, but not exactly, the number. For example, in some embodiments, the term “about” may include values that are within +/−10 percent of the value.

The present disclosure relates generally to methods and systems of transaction processing for giving, including distributing winnings and foundational funds (philanthropy) across one or more communities. In an embodiment, the transaction processing for giving is associated with a lottery jackpot or other form of gaming. According to the North American Association of State and Provincial Lotteries, lotteries took in $70.1 billion in sales in 2014 alone. The gaming industry has grown significantly since that time. Meanwhile, many Americans are in need. For example, according to a March 2021 forecast from Feeding America, over 40 million Americans may experience food insecurity. The disclosed transaction processing system for giving may be used to automatically distribute a portion of a lottery jackpot to (or among), e.g., needy individuals or charitable, non-profit, or non-for-profit organizations, across one or more communities, and/or otherwise.

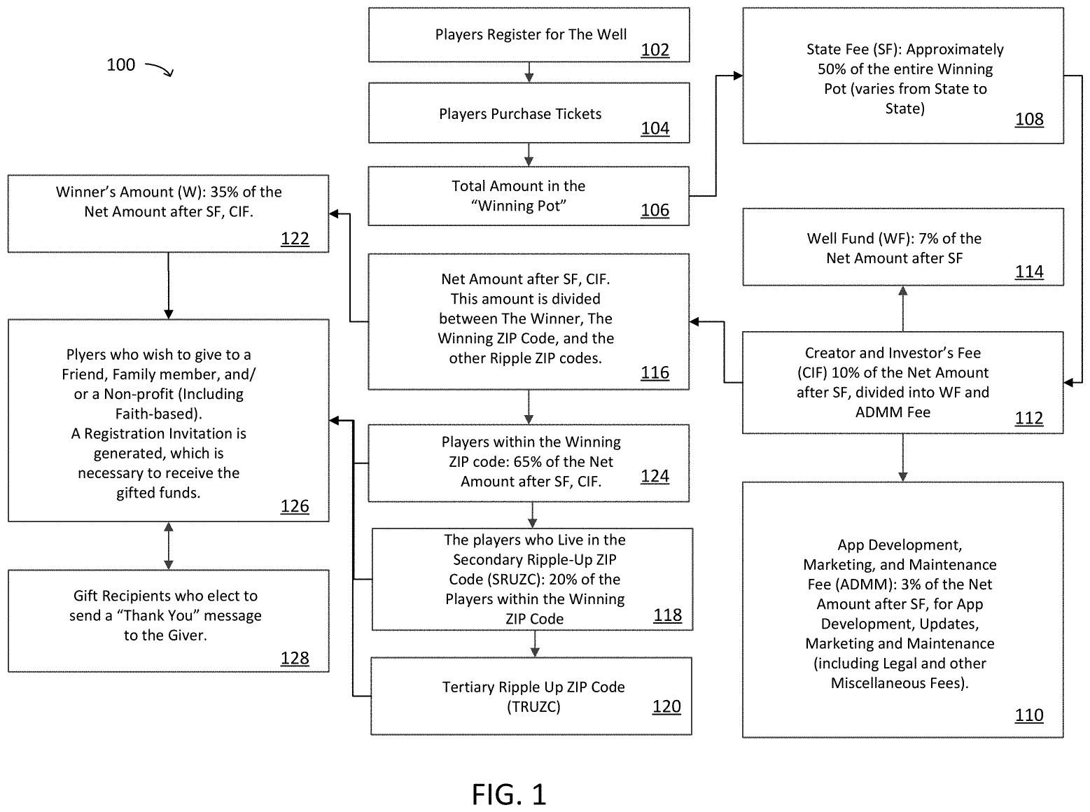

FIG. 1 depicts a flowchart 100 of an example method of distributing a jackpot of a lottery or other game of chance. At step 102, participants (players) enroll/register to participate in a distribution system, herein, generally referred to as a distribution system for giving. Players may register via a website, an application, such as a phone app of the distribution system for giving, a point of sale interface, or other suitable registration interface. In an example, players may register to participate via the website of a government (e.g., state) lottery or, e.g., a lottery included in a virtual environment, such as within an online game. Other gaming environments are also within the scope of this disclosure. The lottery website may include an offer to enroll/register to receive jackpot winnings via the distribution system. As part of the registration process, the distribution system may collect factors, or additional information, from the player, e.g., information required to perform the distribution(s), such as the player's name, taxpayer ID number, bank information, and so forth. The distribution system may request demographic information such as sex, age, race, etc. The distribution system may request additional contact information, such as telephone numbers, e-mail addresses, address, etc. of the player and/or other people associated with the player, such as a next of kin. In some embodiments, the distribution system may ask the player to provide a postal (e.g., ZIP) code, or other indication of the geographical region (e.g., of the state) in which the player resides. In some embodiments, the system may use a location-determining capability, e.g., when the player registers via an app. In other embodiments, the distribution system may, additionally or alternatively, ask the player to provide information regarding their household income, family size and makeup, or other financial or demographic information. The distribution system may allow the payer or registrant to input information related to a non-profit, faith-based organization, or charitable foundation, such as contact information, tax ID number, fundraising targets and progress, and so forth.

In some embodiments, the system or app may automatically determine one or more factors, including a geographical region, e.g., via a location service, or by accessing contact or other information previously provided by the player. In other embodiments, the app may automatically access or include other accessible information, including but not limited to general financial status, e.g., a mean income for a neighborhood based on a postal code or other geographical information. As will be appreciated, any accessible general financial or demographic information may be used. For convenience, the app may present the automatically determined factors for the player to approve (and, in some cases, override) before continuing. However, in some embodiments, the player may be limited or prevented from altering or overriding one or more of the determined factors. For example, the player may be prevented from changing a previously verified address unless the player provides proof of a change of address. Alternatively, or in addition, players may be limited to a certain number of changes to one or more factors during a period of time, or may prevent the player from changing one or more factors within a threshold period of time leading up to buying a lottery ticket. In at least one embodiment, the one or more factors can be updated from an accessible database prior to the end of each game or distribution. The app may apply these and/or other limitations to avoid misuse of the distribution system. Furthermore, the distribution system may require players to execute, at or before purchasing a lottery ticket (or equivalent participation in another gaming system), a binding agreement to distribute winnings according to the system for giving. In some embodiment, the distribution system may allow a lottery winner to register after buying a lottery ticket (and/or after winning a prize) and agree to the binding agreement to distribute winnings according to the system for giving.

At step 104, the registered player purchases one or more lottery “tickets” (i.e., the player agrees to participate in one or more upcoming lottery games/drawings and to pay a certain monetary value for each game). As described above, the player may purchase the lottery ticket(s) via, e.g. a government lottery website (in the case of a government-run lottery, such as a state lottery), or, e.g., using an app of the distribution system for giving, or via another suitable lottery sales system. At step 106, the registered player wins a lottery jackpot in the form of a monetary prize, e.g., a lump sum of an amount of money. Alternatively, as described above, the player may first win a lottery jackpot then (e.g., after winning, but before claiming a prize) register/enroll with the distribution system for giving. In some situations, e.g., due to the nature or structure of the game, the lottery jackpot may be awarded to multiple winners. If all jackpot winners are also registered with the distribution system (either before or after winning the lottery), then the distribution system may manage the entire jackpot. However, in other situations, some or all jackpot winners may not be registered with the distribution system. If only some jackpot winners are registered, then the distribution system may manage the share of the entire jackpot associated with registered winners. In some embodiments, the distribution system actively monitors the lottery system to detect winners of the prize. For example, the distribution system may periodically query a database or other online source of information regarding lottery drawings, winners, and/or prize amounts. In some examples, the distribution system subscribes to the lottery system to receive event notification of drawings, winners, or other events related to the lottery.

The distribution system for giving may first divide the jackpot among stakeholders including, e.g., the player, the taxing entities, and/or beneficiaries of the distribution system for giving. While it varies by location, taxing entities may claim a state fee or tax share 108. In some states, this may be approximately 50% of a lump-sum jackpot. As will be appreciated, taxes may vary by state and/or country. While the player may be normally entitled to receive the other approximately 50%, when enrolled in the distribution system for giving described herein, the winning pot 106 minus taxes 108 may be divided into one or more portions, including a creator's fee and inventor's fee (“CIF pot”) 112 and Remaining Lottery Pot 116.

In one embodiment of the invention described herein, an example CIF pot 112 may comprise 10% of the net winnings after the state fee has been paid. In other embodiments, the CIF Pot may be greater than or less than 10% of the net winnings. The CIF Pot 112 may be divided between an administration fee 110 and a Well Fund 114. In at least one embodiment, the administration fees 110 may comprise a predetermined fraction of the CIF Pot 112. These fees 110 may be applied to, e.g., the cost of software (e.g., app) development, marketing, maintenance, updates, and so forth, as well as legal and other miscellaneous fees, etc. In at least some embodiments, funds may be reserved for both a general charitable/giving purpose or fund 114 and an app development/marketing/maintenance fee 110. In at least one embodiment, the Well Fund 114 may comprise a predetermined fraction of the CIF Pot 112. As may be appreciated, the various divisions of the winning pot may be made in any desirable way based on the overall winnings, net winnings, or other suitable division.

In some embodiment, a portion of the jackpot may be placed into one or more Remaining Lottery Pots, i.e., the Entire Winner's Amount 116. After accounting for, e.g., taxing entities, endowment funds, administrative fees, etc., the Entire Winner's Amount 116 may be a fraction of the total jackpot. As may be appreciated, this could still be several million dollars to hundreds of millions of dollars, depending on the size of the jackpot. The Entire Winner's Amount 116 may be distributed to the winning player and one or more accounts within the distribution system for giving, including one or more community distribution(s), one or more charitable/giving purpose(s), one or more community funds, and/or one or more other purposes or accounts. As will be appreciated with the disclosures herein, one or more distributions, comprising any portion of the overall winnings, may be made.

In at least one embodiment, discussed above where the state fee may be 50%, and the CIF may be 10% of the net winnings (5% of the Winning Pot 106) after the state fee has been paid, the Entire Winner's Amount 116 comprises 45% of the overall winnings 106. As will be appreciated, these percentages are illustrative examples, and other percentages and fractions for these and other quantities may be applied without departing from the disclosed inventive concept.

As discussed, the winning player may a receive a share 122 of the Remaining Lottery Pot 116. However, in most embodiments, a responsible payout and distribution method is applied to the Entire Winner's Amount 116. That is, in most embodiments, when a player is enrolled in the distribution system for giving, some of the Entire Winner's Amount 116 may be further distributed to others. In one embodiment, the winning player will receive 35% of the Entire Winner's Amount 116 and 65% will be reserved for one or more distributions. However, other percentages may be used. For example, in one embodiment, the portion reserved for charitable/giving purposes may be 10% of the Remaining Lottery Pot 116. In another embodiment, the portion reserved for charitable/giving purposes may be 45% of the Remaining Lottery Pot 116. In still other embodiments, the portion reserved for charitable/giving purposes may be 90% of the Entire Winner's Amount 116. In some embodiments, the portion reserved for charitable contributions or distributions is preselected by the distribution system for giving. In other embodiments, the portion reserved for the charitable contributions or distributions may be preselected and/or modified by the player prior to winning the lottery. In still other embodiments, the portion reserved for charitable contributions or distributions may be selected and/or modified by the player after winning the lottery. In at least one embodiment, the player may, after winning the lottery, only increase the portion reserved for charitable contributions or distributions.

In most embodiments, the system may also distribute at least a portion of the Entire Winner's Amount 116 to other registered players. In at least some embodiments, the distribution method(s) to others may be configured to provide, e.g., supplemental economic support for individuals, families, non-profit organizations including faith-based organizations, communities, states, territories, etc. As may be appreciated, this may allow for some of the winnings to trickle up to one or more other communities. Thus, the registered player/winner receives, instead of the entire distribution, a generous portion of the distribution and the ability to help others.

In some embodiments, the system distributes at least a portion of the Entire Winner's Amount 116 to other registered players within the winning ZIP code. That is, in various embodiments, the player's winnings may be distributed to others within the community that the player lives (or otherwise is associated or identifies with). In other embodiments, the winning ZIP code may be where the game was played or the ticket was purchased. In still other embodiments, the winning zip code may be a ZIP code proximate to the winning player's ZIP code. In most embodiments, the distribution will be limited to others who are also enrolled within the distribution system for giving described herein. In other embodiments, the player's winnings may, additionally or alternatively, be distributed to others within one or more communities proximate to the player's home. In other embodiments, the player's winnings may, additionally or alternatively, be distributed to others within the state the player lives. In some embodiments, the player's winnings may, additionally or alternatively, be distributed to communities in need. In at least some embodiments, the winnings are distributed to communities in need proximate to where the player lives. In some situations, the community in need may be defined by users who have different ZIP codes but otherwise have one or more identified factors in common, which may include but is not limited to income level, single-parent status, home ownership or rental rates, poverty level, number of children, refugee or asylum status, diversity status, or others. In some embodiments, the distribution system may use one or more giving algorithms, discussed more herein, to distribute a share to other registered users.

Specifically, a portion of the remaining winnings 116 may include a giving portion 124 to be distributed according to one or more giving algorithms. Giving algorithms may be based on participants who have also registered with the distribution system for giving. The giving algorithms may weigh one or more available factors to identify one or more economically challenged geographical region(s). In some embodiments, the available factors may include demographic information. Demographic information includes but is not limited to household income or average household income, lower levels of home ownership, lower levels of car ownership, the level of reliance on public assistance within the community, lower to average home ownership rates, lower to average car ownership rates, the rates or number of single parents in the community, lower to average educational rankings of the schools in the community, average house size, the ratio of apartments to homes in the neighborhood, the number of renters in the community.

In some embodiment, the algorithm obtains, in real-time, e.g., at the time of distribution, demographic information from one or more online sources. Examples of online sources include sources of mapping information such as openstreetmap.org, maptiler.com, corelogic.com, and so forth. In some embodiments, the proximity of the community to the winning player's community may weigh in favor of distribution. Of course, as may be appreciated, any measure of a community may be used.

In some embodiments, the factors considered by the algorithm may weigh against distribution to a community. For example, in some embodiments, a well to do community may be less likely to receive a distribution. In various embodiments, factors that could weigh against distribution include but are not limited to high-net worth, average income, average house size, higher home ownership rates, and higher car ownership rates. In some embodiments, the distance of the community from the player's community may weigh against distribution. In some embodiments, the available factors may, additionally or alternatively, include whether registered participants or the community has benefitted from a prior winning. In at least one embodiment, the algorithm may strongly weigh a distribution to a community from prior winnings as a factor against another distribution thereto. However, as may be appreciated, such factors may not affect distribution. For example, such factors may still be outweighed by other needs considered about a community. In addition, in at least some embodiments, factors weighing against distribution may not be considered and/or bypassed by a randomizer.

In various embodiments, the algorithm may utilize various ways to compare or weigh each factor. In some embodiments, the algorithm may identify one or more factors to compare and weigh each against each other without a weighting. For example, the algorithm may identify communities within 20 miles of the winning player and compare three factors: (1) the percentage of families who rely on assistance, (2) the number of renters in the community, and (3) the average household income. The algorithm may compare Community X, where the number of people who rely on assistance is 40%, the number of renters in the community is 50%, and the average household income is $45,000 to Community Y, where the number of people who rely on assistance is 35%, the number of renters in the community is 40%, and the average household income is $30,000. In at least one embodiment, the algorithm may determine that Community X has more need based on a higher percentage of people who rely on assistance and a higher percentage of renters and therefore determine to make the distribution to Community X. In at least one other embodiment, where the algorithm weights the factors, the algorithm may weight the average household income. For instance, for households at or below the poverty level, the household income factor may be weighted at 60%, which may diminish a couple percentage for every $5,000 over the poverty level. Thus, Community Y's lower average income may account for more than 50% of the determination resulting in a distribution to Community Y. As will be appreciated, any known way to weight a factor may be used and any factor may be weighted over any other factor.

One or more randomizers may also be used. In some embodiments, a randomizer may be used to select one or more factors to be considered or used in the algorithm. In some embodiments, a randomizer may, additionally or alternatively, weight one or more factors and/or select the weight to be accorded to the one or more factors. In some embodiments, the randomizer may create a new algorithm, by randomization, for the distribution in each game.

In some embodiments, where the algorithm is used to create a list of those communities or users to potentially distribute part of the remaining winnings 116 to, a randomizer may select one or more from the list for actual distribution. For instance, if the algorithm identifies three communities within fifty (50) miles of the winning player for potential distribution, the randomizer may randomly select one or two of those communities to actually distribute the remaining winnings to. As will be appreciated, this may be especially useful when a tie emerges between multiple communities based on the giving algorithm. In some embodiments, a randomizer may, additionally or alternatively, be used to narrow an initial list of potential communities considered by the algorithm.

In some embodiments, some of the Remaining Lottery Pot 116 may, additionally or alternatively, be distributed to endowment funds, to charitable organizations, scholarships, etc. In some embodiments, an endowment fund may be created to feed those within one or more communities. In other embodiments, an endowment may be created to teach people, e.g., about fundamental principles in health, wellness, finance, etc. and to demonstrate how to apply those principles to create balance in their daily lives. In one embodiment, the endowment fund may help serve and build up the community in which the player lives. In other embodiment, the endowment fund may help serve and build up communities proximate to where the player lives but which are more in need than the community in which the player lives. The Remaining Lottery Pot 116 may generally help serve and build up communities within each state and country around the world. As one in the art may appreciate, any endowment fund may be created or funded. As may be appreciated, a giving algorithm may be used to identify the fund, organization, or scholarship to distribute funds to.

In some embodiments, the charitable portion 124 may be distributed evenly to all registered participants of the distribution system for giving in the same geographical region (e.g., ZIP code) as the winning player. That is, the distribution system for giving may identify the geographical region associated with the winning player as a winning geographical region (e.g., winning ZIP code) and distribute the charitable portion 124 to other registered users who reside in the same geographical region. In at least one embodiment, the registered participant must have purchased a ticket for the same game. In other embodiments, the registered participant must have played the lottery within a specified time period, e.g., the last 30 days. In other embodiments, no such play requirements exist. The distribution system for giving may distribute funds to accounts of the participants (e.g., accounts maintained for the participants by the distribution system for giving). In some examples, the distribution system for giving distributes funds via a digital payment system such as the Automated Clearing House (ACH) network or Zelle, or a commercial mobile payment system, such as Venmo or PayPal. In an embodiment, the distribution system for giving includes a bespoke payment system for managing and distributing funds. As may be appreciated, any available digital payment, transfer, or distribution system may be used. In at least one embodiment, the distribution system for giving may distribute funds to those within a specified area, regardless of any registration with the chartable distribution system described herein.

In some embodiments, the distribution system for giving may distribute each winner's or other user's share separately. For example, the first winner's share may be distributed within the first winner's community, and the second winner's share may be distributed within the second winner's community. In situations where all winners share the same ZIP code and/or identify with the same communities, the distribution system for giving may manage and/or distribute the first winner's share and the second winner's share jointly. In at least one embodiment, the distribution system may distribute the one or more shares through the state or other entity running the game of chance.

Registered participants who receive part of the winning pot 106 may also share all or a portion of their winnings with others. For example, in some embodiments, a registered participant may have previously indicated a preference for paying a portion of their proceeds forward. That is, when the participant registers with the distribution system for giving, the system may ask the participant to select a secondary distribution method. In one example, users may pre-agree to further pass a portion 118 of their distribution of the lottery winnings to registered participants who reside in another (secondary) geographical region (e.g., ZIP code). In some embodiments, this may be 20% of the distribution made to the registered participant. In other embodiments, more or less than 20% may be further distributed.

In some embodiments, the distribution system for giving will automatically select the most economically challenged geographical region to receive the “pass forward” portion 118 of the distribution through the use of one or more charitable algorithms. For example, the distribution system for giving may use algorithms to select the most economically challenged geographical region(s) based on available demographic information, such as household income, level of reliance on public assistance, or other measures of need. In some embodiments, the algorithm used may be the same as the one employed to determine the initial distribution list. In other embodiments, the algorithm may be different. In some examples, the distribution system for giving selects the secondary “pass forward” geographical region at the time the participant registers with the distribution system for giving. Alternatively, the distribution system for giving may rank-order a set of geographical regions (e.g., ZIP codes within a state) at the time of distribution, e.g., the time the lottery jackpot is awarded. Thus the “pass forward” portion 118 of the lottery winnings may be further distributed according to a secondary distribution method selected by the user.

The “pass forward” approach described above may lead to “ripple effect.” That is, participants who receive “pass forward” distributions may have also indicated a preference to pass forward a portion of their distribution. In some embodiments, the participant may elect to pass forward 20% of any distribution. In other cases, more or less than 20% may be selected. In various embodiments, the distribution system for giving may determine a next-most-needy (tertiary) geographical region to receive the “ripple up” distribution 120. The “ripple effect” may continue through the next-most-needy (quaternary) geographical regions, etc. In some embodiments, the distribution system for giving continues to “pass forward” distributions to additional geographical regions until the distribution falls below a threshold value. In other embodiments, the distribution may be limited to a pre-selected of “pass forward” events.

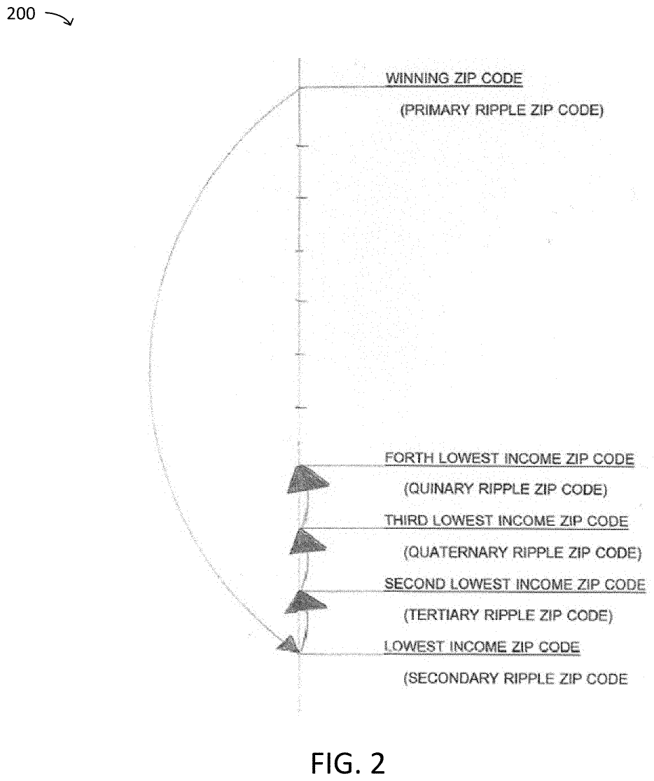

FIG. 2 shows an illustration 200 of the “Ripple Up” movement between the Winning Zip Code (The Primary Ripple Zip Code), the Secondary “Ripple Up” Zip Code, and all other “Ripple Up ZIP Codes. After funds are transferred to The Winning ZIP Code, the rest of the Ripple Up ZIP Codes may be selected beginning with the lowest income zip code within the state, and from there, moving up to the Second Lowest Income ZIP Code (Secondary Ripple Up ZIP Code), then to the Third Lowest Income ZIP Code (Tertiary Ripple Up Zip Code), and so on and so forth until all ZIP codes within the state have won. After that, the process begins again. A new game begins, starting with the next Ripple Up ZIP Code, from where the prior game left off, allowing for gifting to many zip codes within the state.

In various embodiments, the Remaining Lottery Pot 116 may be made to a charitable fund, not-for-profit, or other organization. As may be appreciated, other distributions of funds toward charitable and/or administrative purposes are also within the scope of the disclosure. In some embodiments, enrolled participants who receive a portion of lottery winnings (e.g., by winning the lottery, or by receiving a portion of the winnings by residing in the same ZIP code as the lottery winner, or by receiving a “pass forward” distribution, etc.) may also wish to give some or all of their portion of the lottery winnings to an individual or organization (e.g., in addition to, or in lieu of a geographically based “pass forward” distribution). For example, the participant may wish to donate some or all lottery winnings to a needy friend or family member, or a non-profit or not-for-profit organization, such as a faith-based organization. In some embodiments, the organizations may register with the distribution system for giving. In some examples, the distribution system for giving is configured to select a charitable fund, not-for-profit, or other organization to receive a “pass forward” distribution. For example, the distribution system for giving may select a recipient randomly, or according to an algorithm from a set of candidate organizations. In at least one embodiment, the distribution system may periodically query a database or other online source of information regarding the funding progress of one or more organizations. In some examples, the distribution system for giving receives information related to candidate organizations from one or more online databases and/or websites, such as benefactorgroup.com and/or givingusa.org.

At step 126, the participant may select, via the distribution system for giving, whether they wish to give a portion of their winnings to a designated individual or organization. In various embodiments, the participant may select whether to give a portion of their winnings or distribution prior to the lottery. In other embodiments, the selection may additionally be made after the lottery. In at least some embodiments, the participant may identify the individual or organization they wish to receive a portion of their distribution. For example, the user may interact with the distribution system for giving using a phone app or a web interface, or other suitable selection interface. Using the selection interface, the user may provide information about the intended recipient, including contact information usable by the distribution system for giving, such as e-mail. In response the distribution system for giving may contact the designated recipient, e.g., including an invitation to enroll and participate in the distribution system for giving. Once the designated recipient registers with the distribution system for giving (and with the associated lottery system), the recipient may receive (e.g., access/withdraw) their gifted funds. In some examples, the charitable system may first obtain pertinent information from the intended recipients, such as a taxpayer identifier, which may be required in order for certain recipients (e.g., non-profit organizations) before they can withdraw funds.

In other embodiments, the participant may select one or more individuals or organizations, or types of individuals or organizations, and the distribution system for giving will distribute some of the participants winnings to one or more of those identified individuals or organizations. For example, a participate may select three known individuals, one known charity, and non-for-profit organizations providing shelter to those in need and an algorithm or randomizer will identify one or more of these individuals or groups to distribute some of the participant's winnings. In at least one embodiment, the participant may also elect what organizations not to include in a distribution. In embodiments where a distribution to an organization is made, different factors may, additionally or alternatively, be used. Factors may include, but are not limited to, the number of employees at the organization, the budget size of the organization, recent fund raising efforts of the organization, the current fund raising goals of the organization, the percentage of the fund raising goals made to date, the number or type of individuals impacted by the organizations efforts each year, the organizations recent charitable ratings, the organization's program efficiency ratio. As may be appreciated, any factor may be used. As may also be appreciated, one or more factors may be used and/or weighted in accordance with the prior disclosures herein.

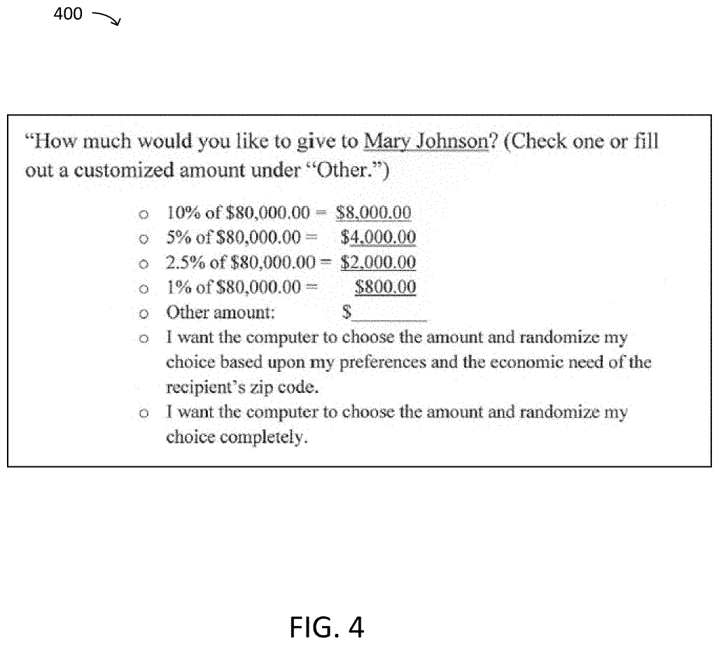

In some embodiments, the participant may elect to have the distribution system for giving randomly choose recipients, or donation amounts, or other parameters. For example, when a participant receives a distribution based on residing in a winning geographical region, the participant may elect to have the distribution system for giving randomly choose a recipient to receive some or all of the player's distribution. In some examples, the player provides a list of potential recipients (along with pertinent information, such as contact information, taxpayer identifier, address, or the like) for the distribution system for giving to choose from. The distribution system for giving may randomly choose from the list of potential recipients, or may select the recipient based on one or more criteria. For example, the distribution system for giving may choose the recipient based on the geographical location of the recipient, e.g., using a need-based approach, such as selecting the potential recipient from the most needy geographical region. In some examples, the player provides a range of gift values (e.g., between 25 and 60%), so that the distribution system for giving may choose a value within the range for the donation. The distribution system for giving may select a donation amount, e.g., using a need-based approach, such as selecting the donation amount based on demographics of the recipient, such as the mean per-capita income of residents of the recipients geographical region. FIG. 4 illustrates an example input form 400, e.g. as displayed on a web page, mobile device app, or other graphical interface, querying the participant to select a donation amount for an individual recipient.

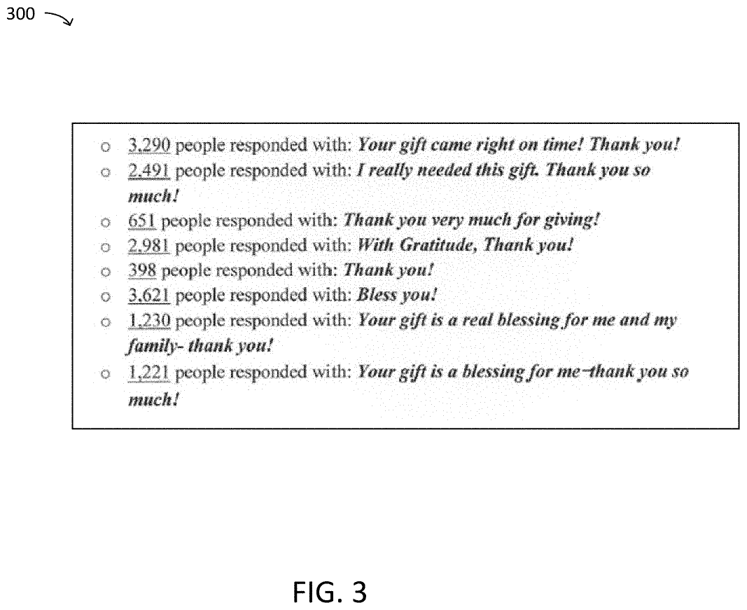

In some examples, after the recipient receives funds donated by a participant, the recipient may, at step 128, send a confirmation to the donor. The confirmation may be in the form of a “Thank You” note or testimonial sent via e-mail or sent within the phone app or other interface of the distribution system for giving. For example, the distribution system for giving may include a number of pre-defined confirmation responses to send to the donor. The recipient may choose a predefined response or may provide a custom or personal response. In the case where the recipient has provided a taxpayer identifier, the distribution system for giving may automatically insert the taxpayer identifier into the response message before displaying the message to the donor (or before e-mailing or otherwise making the response available to the donor). Furthermore, the distribution system for giving may monitor which messages are selected and sent as confirmation responses, and may make a summary available to the donor. For example, in the case where the donor uses a mobile-device app, the app may display a list of the messages received by the donor and may order the list, e.g., by the frequency of use of each message and may optionally include a tally or count of the number of times each message was received. FIG. 3 illustrates an example output 300, e.g., displayed on a web page or by a mobile device app or other display interface, listing the received confirmation responses. The newly enrolled recipient, like all enrolled participants, will be eligible to indicate a preference for paying a portion of their proceeds forward, and/or select, via the distribution system for giving, one or more individual or organizations to receive gifts donated through the distribution system for giving (e.g., in response to receiving a distribution from another participant).

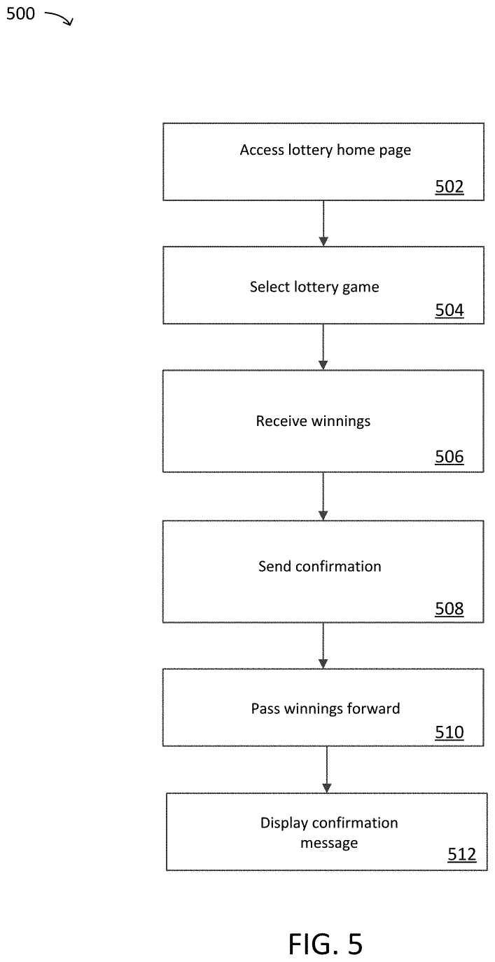

FIG. 5 depicts a flowchart 500 of an example interface with a distribution system for giving associated with a state lottery. At step 502, the participant may access the home or main page of the lottery system. The home page may provide instructions for buying lottery tickets, claiming prizes, and so forth. The home page may also provide instructions for enrolling/registering with the distribution system for giving, e.g., prior to purchasing a lottery ticket. The instructions may include instructions for downloading/installing an app, e.g., on a mobile device and using the app to complete the enrollment process and/or purchase lottery tickets. At step 504, after registering/enrolling with the distribution system for giving, the participant selects one or more available lottery games to play and purchases one or more tickets. At step 506, the participant receives winnings, either as a lottery winner, or as a secondary recipient of winnings, e.g., from another participant in the distribution system for giving. In some examples, the mobile app notifies the participant that he has received a portion of lottery winnings. The mobile app may display the amount of the winnings and may display an indication that the distribution system for giving has already transferred the winnings into an account of the participant (e.g., an account maintained for the participant by the distribution system for giving). In some examples, the mobile app continues the message of charity, giving, altruism, and fiscal responsibility. For example, the mobile app may provide information to the recipient about sound investment strategies, scaled by the value of the portion of lottery winnings received. For example, the mobile app may present information related to paying off debt, financing higher education, and so forth, and may include references to sources of useful information.

The mobile app may also prompt the participant to select a message to include in a confirmation response to the donor. At step 508, the mobile app transmits the selected confirmation response to the donor. In some examples, the donor's mobile app notifies the donor of the confirmation response, and or displays the response or a summary of received responses, as shown in FIG. 3. The step 510, the mobile app prompts the participant to pay forward some or all of the received winnings. For example, the mobile app may prompt the participant to select one or more individual recipients (e.g., family members, friends, etc.) or organizational recipients (e.g., faith-based and/or charitable organizations) and an amount to donate (or, as described above, request the distribution system for giving to select the recipient and/or donation amount). After the recipient(s) receive their distributions, the recipient(s) may transmit, e.g., via their mobile app, a confirmation response indicating that the recipient(s) have received their donation from the participant. At step 512, the mobile app notifies the participant and/or displays the confirmation message.

The distribution system for giving is not limited to distribution of lottery winnings. The system may also be used for a wide variety of foundational giving or other giving. For example, users of all kinds, including, but not limited to, estates, private individuals, foundations, and other entities may gift an amount of money to be distributed, by the distribution system for giving, in a similar manner to the distribution of lottery jackpot winnings described above, e.g., including the “ripple up” distribution to primary, secondary, tertiary ZIP codes, and so forth. That is, the distribution system for giving may distribute the gift to all registered participants of the distribution system for giving (e.g., regardless of whether they have also purchased a lottery ticket) within a needy geographical area. As described above, recipients may have the option to forward some or all of their distribution to selected individuals or organizations, regardless of whether they are current participants. As described above, if the recipient is not a current participant, the system may invite the recipient to join. In some examples, the distribution system for giving may revise its distribution method to better accommodate smaller gift amounts. For example, for gifts under a threshold amount (e.g., $10,000,000), the distribution system for giving may only distribute portions of the gift to geographical areas with a population greater than a threshold level (e.g., 10,000 registered residents), so that each recipient receives a meaningful/impactful gift. The distribution system for giving may also modify the “ripple up” approach described above for smaller gifts, e.g., by reducing the number of ZIP codes the gift will “ripple” through, or terminating the “ripple” approach when any single gift falls below a threshold value, such as $100 or $1,000 (or other meaningful threshold).

The distribution system for giving may also present the donor with additional distribution options, such as randomly selecting a specified number (e.g., 100, 500, 1,000) of registered participants in a selected state (or country) who live in a needy geographical area, causing the distribution system for giving to divide the total gift among the selected recipients. Alternatively, the donor may select a specified monetary amount (e.g., $1,000) to distribute to each recipient, causing the distribution system for giving to randomly select an appropriate number of recipients to receive the entire donation.

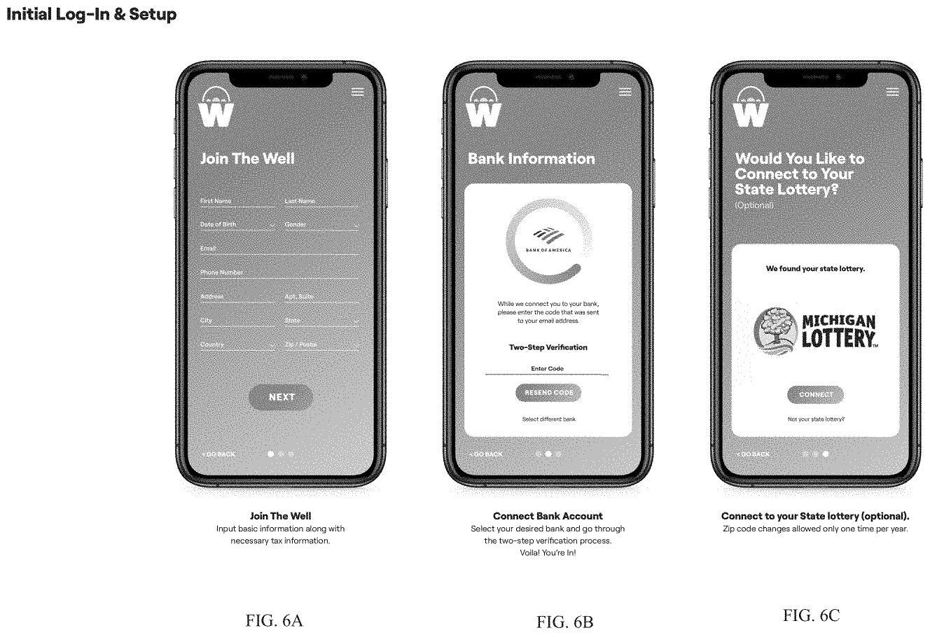

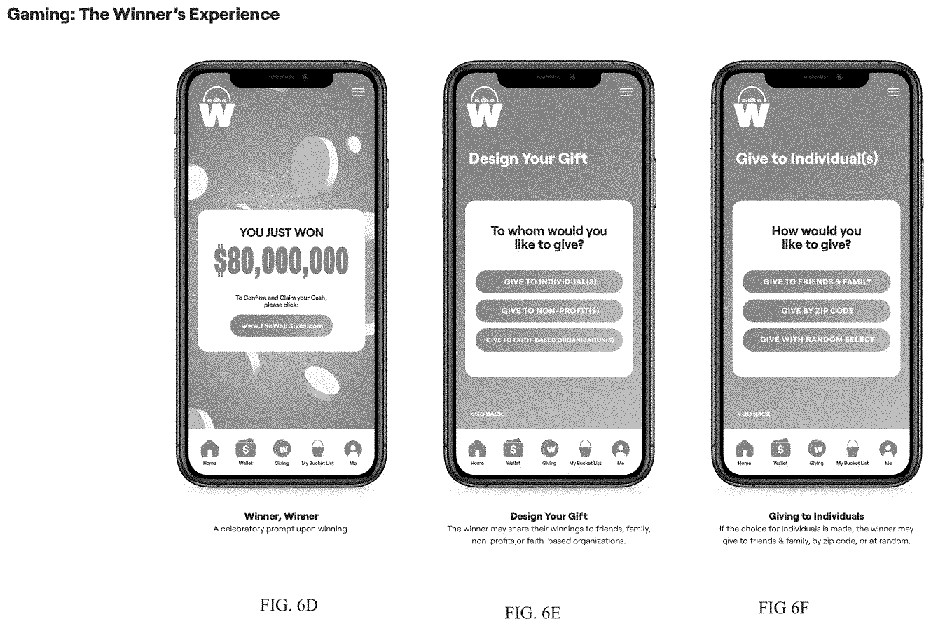

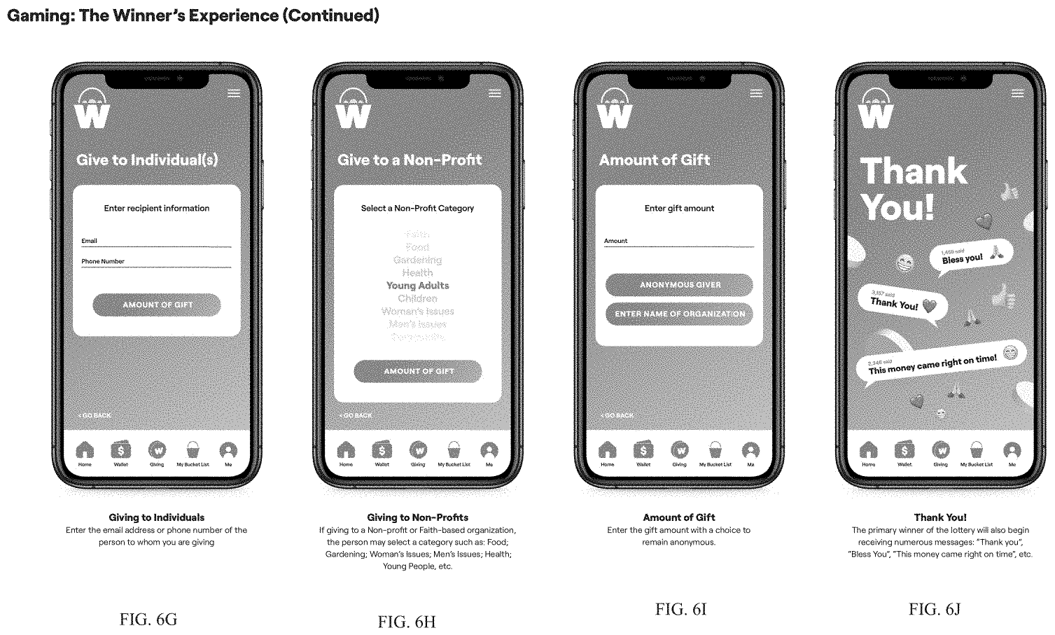

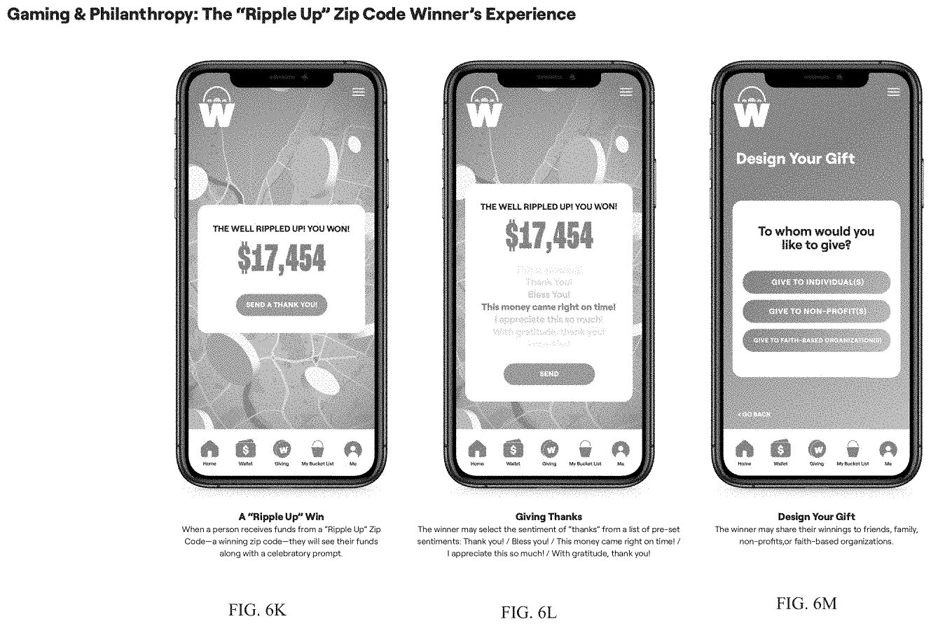

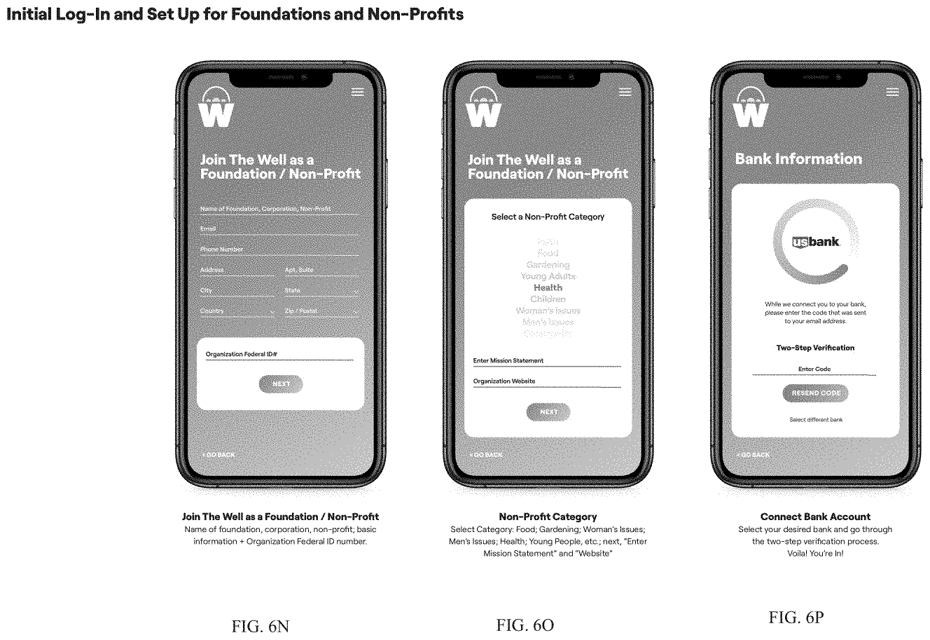

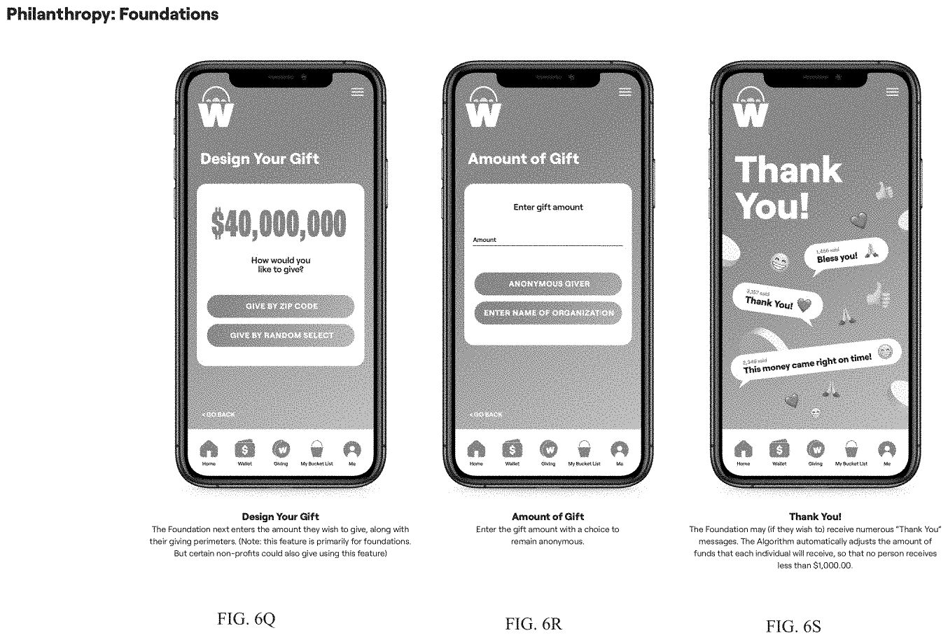

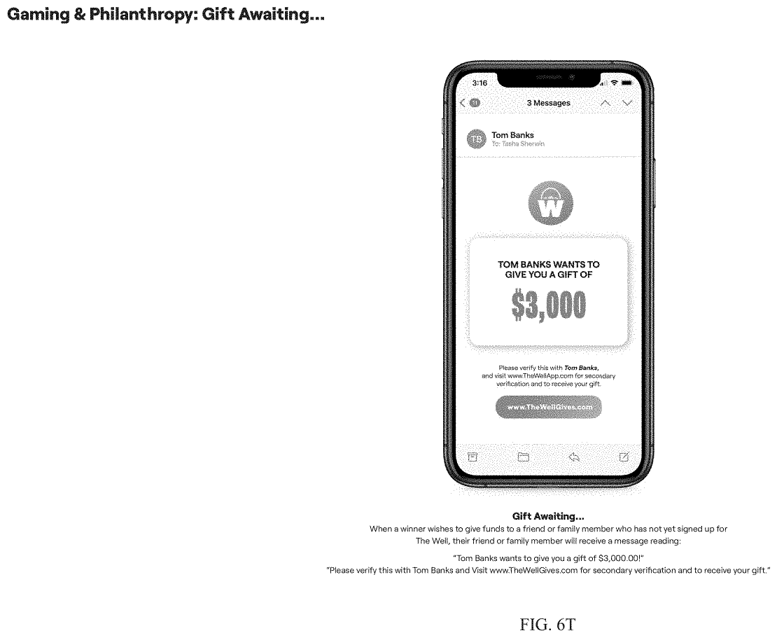

FIGS. 6A-6T illustrate user interfaces for an example mobile app embodiment of the distribution system for giving. FIG. 6A illustrates an example interface for participants (players) to enroll/register to participate in a distribution system. FIG. 6B illustrates an example interface for players to provide additional information, such as banking information allowing the distribution system to transfer winnings or other funds to the player. FIG. 6C illustrates an example interface for optionally interfacing with a state lottery system via the distribution system. FIG. 6D illustrates an example notification of winning at least a share of a monetary prize. FIGS. 6E-6I illustrate example interfaces customizing the giving process by providing recipient information, a gift amount, and/or information allowing the distribution system to select (e.g., using a random selection process) one or more gift recipients. FIG. 6J illustrates an example interface displaying a message received from one or more donees (e.g., one or more recipients of a gift from the distribution system).

FIG. 6K illustrates an example interface notifying a registered player of a “pass forward” gift from another registered player. The recipient of the “pass forward” gift may respond to the donor with a “Thank You” note (as shown in the example interface of FIG. 6L). FIG. 6M illustrates an interface for the “pass forward” gift recipient to donate some or all of his windfall in a similar fashion to FIGS. 6E-6I. FIGS. 6N-6P illustrate example interfaces for non-profits (or similar organizations) to join the distribution system, and thus, be eligible to receive distributions. FIGS. 6Q-6S illustrate example interfaces for making a donation to a foundation or other recipient, e.g., outside the context of a lottery or gaming system. FIG. 6T illustrates an example interface inviting a candidate donee to join the distribution system and receive a gift.

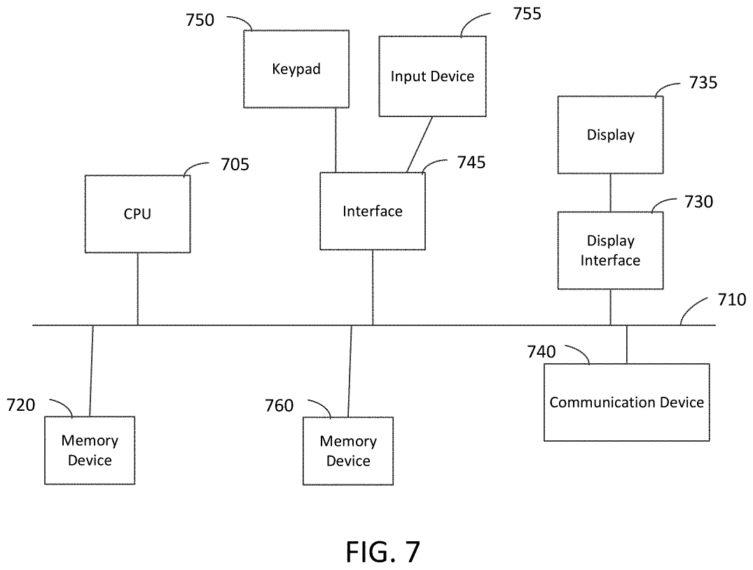

FIG. 7 illustrates example hardware that may be used to contain or implement program instructions. A bus 710 serves as the main information highway interconnecting the other illustrated components of the hardware. Processor 705 is a central processing device of the system, configured to perform calculations and logic operations required to execute programming instructions. As used in this document and in the claims, the terms “processor” and “processing device” may refer to a single processor 705 or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 720. Read only memory (ROM) and random-access memory (RAM) constitute examples of non-transitory computer-readable storage media 720, memory devices or data stores as such terms are used within this disclosure.

Program instructions, software or interactive modules for providing the interface and performing any querying or analysis associated with one or more data sets may be stored in the memory device 720. Optionally, the program instructions may be stored on a tangible, non-transitory computer-readable medium such as a compact disk, a digital disk, flash memory, a memory card, a universal serial bus (USB) drive, an optical disc storage medium and/or other recording medium.

An optional display interface 730 may permit information from the bus 710 to be displayed on the display 735 in audio, visual, graphic or alphanumeric format. Communication with external devices may occur using various communication ports 740. A communication port 740 may be attached to a communications network, such as the Internet or an intranet.

An optional display interface 730 may permit information from the bus 710 to be displayed on a display device 735 in visual, graphic or alphanumeric format, such on an in-dashboard display system of the vehicle. An audio interface and audio output (such as a speaker) also may be provided. Communication with external devices may occur using various communication devices 740 such as a wireless antenna, a radio frequency identification (RFID) tag and/or short-range or near-field communication transceiver, each of which may optionally communicatively connect with other components of the device via one or more communication system. The communication device(s) 740 may include a transmitter, transceiver, or other device that is configured to be communicatively connected to a communications network, such as the Internet, a Wi-Fi or local area network or a cellular telephone data network, or to make a direct communication connection with one or more nearby devices, such as a Bluetooth transmitter or infrared light emitter.

The hardware may also include a user interface sensor 745 that allows for receipt of data from a keyboard or keypad 750 or other input devices 755 such as, a joystick, a touchscreen, a touch pad, a remote control, a pointing device and/or microphone. Digital image frames also may be received from a camera 760 that can capture video and/or still images.

In this document, an “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

The terms “processor” and “processing device” refer to a hardware component of an electronic device that is configured to execute programming instructions, such as a microprocessor or other logical circuit. A processor and memory may be elements of a microcontroller, custom configurable integrated circuit, programmable system-on-a-chip, or other electronic device that can be programmed to perform various functions. Except where specifically stated otherwise, the singular term “processor” or “processing device” is intended to include both single-processing device embodiments and embodiments in which multiple processing devices together or collectively perform a process.

While the invention has been described with specific embodiments, other alternatives, modifications and variations will be apparent to those skilled in the art. Accordingly, it will be intended to include all such alternatives, modifications, and variations within the spirit and scope of the appended claims.

1. A method of processing a giving transaction, the method comprising:
receiving, from a plurality of users, enrollment information including:
a postal code associated with each of the plurality of users;
an indication that each of the plurality of users has entered an upcoming game of chance associated with a monetary prize;
registering the plurality of users and the corresponding enrollment information;
in response to a registered user winning a prize share which consists of some or all of the monetary prize associated with the game, identifying a winning postal code,
wherein the winning postal code is based on the enrollment information of the registered user that won the prize share;
distributing a primary portion of the prize share to the registered user that won the prize share; and
distributing a remaining portion of the prize share by:
distributing a first portion of the remaining portion of the prize share to the plurality of registered users having an associated postal code that matches the winning postal code; and
distributing a second portion of the remaining portion of the prize share to a plurality of other users.

2. The method of claim 1, wherein:
the upcoming game of chance is a lottery;
the indication that the user has entered the upcoming game of chance associated with the monetary prize comprises information associated with a ticket for the lottery; and
distributing the remaining portion of the prize share comprises:
identifying one or more economically challenged communities based on demographic information; and
distributing at least a portion of the second portion of the remaining portion to members of the one or more identified economically challenged communities.

3. The method of claim 2, wherein:
identifying the one or more economically challenged communities based on the demographic information comprises rank-ordering a plurality of geographical regions based on the demographic information; and
distributing the at least a portion of the second portion of the remaining portion to the members of the one or more identified economically challenged communities comprises distributing the at least a portion of the second portion of the remaining portion to residents of the plurality of geographical regions based on the rank order.

4. The method of claim 2, wherein:
the demographic information includes mean household income; and
distributing the at least a portion of the second portion of the remaining portion to the members of the one or more identified economically challenged communities comprises:
transmitting an enrollment request to at least one member of the one or more identified economically challenged communities; and
in response to receiving an enrollment reply from the at least one member,
distributing the at least a portion of the second portion of the remaining portion to the at least one member.

5. The method of claim 1, wherein:
the enrollment information further comprises, for at least one user:
donation information comprising:
a recipient identifier;
recipient contact information; and
a donation amount; and
distributing the remaining portion of the prize share comprises:
transmitting an enrollment request to the identified recipient using the recipient contact information; and
in response to receiving an enrollment reply from the identified recipient, distributing at least a portion of the donation amount to the identified recipient.

6. The method of claim 1, wherein distributing the remaining portion of the prize share comprises:
for one or more candidate recipients, receiving identifying information comprising:
a recipient identifier; and
recipient contact information;
applying a random process to select at least one donee from the one or more candidate recipients; and
distributing at least a portion of the second portion to the selected donee.

7. The method of claim 1, wherein one or more of the distributions uses a digital payment system.

8. The method of claim 1, wherein distributing the remaining portion of the prize share comprises distributing some or all of the second portion to one or more recipients using a random selection process.

9. A system for processing a giving transaction, the system comprising:
a processor; and
a memory that stores programming instructions that are configured to cause the processor to:
receive, from a plurality of users, enrollment information including:
a postal code associated with each of the plurality of users;
an indication that each of the plurality of users has entered an upcoming game of chance associated with a monetary prize;
register the plurality of users and the corresponding enrollment information;
in response to a registered user winning a prize share which consists of some or all of the monetary prize associated with the game, identify a winning postal code,
wherein the winning postal code is based on the enrollment information of the registered user that won the prize share;
distribute a primary portion of the prize share to the registered user that won the prize share; and
distribute a remaining portion of the prize share by:
distributing a first portion of the remaining portion of the prize share to the plurality of registered users having an associated postal code that matches the winning postal code; and
distributing a second portion of the remaining portion of the prize share to a plurality of other users.

10. The system of claim 9, wherein:
the upcoming game of chance is a lottery;
the indication that the user has entered the upcoming game of chance associated with the monetary prize comprises information associated with a lottery ticket; and
the instructions that are configured to cause the processor to distribute the remaining portion of the prize share comprise instructions that are configured to cause the processor to:
identify one or more economically challenged communities based on demographic information; and
distribute at least a portion of the second portion of the remaining portion to members of the one or more identified economically challenged communities.

11. The system of claim 10, wherein:
the instructions that are configured to cause the processor to identify the one or more economically challenged communities based on the demographic information comprise instructions that are configured to cause the processor to rank-order a plurality of geographical regions based on the demographic information; and
the instructions that are configured to cause the processor to distribute the at least a portion of the second portion of the remaining portion to the members of the one or more identified economically challenged communities comprise instructions that are configured to cause the processor to distribute the at least a portion of the second portion of the remaining portion to members to residents of the plurality of geographical regions based on the rank order.

12. The system of claim 10, wherein:
the demographic information includes mean household income; and
the instructions that are configured to cause the processor to distribute the at least a portion of the second portion of the remaining portion to the members of the one or more identified economically challenged communities comprise instructions that are configured to cause the processor to:
transmit an enrollment request to at least one member of the one or more identified economically challenged communities; and
in response to receiving an enrollment reply from the at least one member, distribute the at least a portion of the second portion of the remaining portion to the at least one member.

13. The system of claim 9, wherein:
the enrollment information further comprises, for at least one user:
donation information comprising:
a recipient identifier;
recipient contact information; and
a donation amount; and
the instructions that are configured to cause the processor to the remaining portion of the prize share comprise instructions that are configured to cause the processor to:
transmit an enrollment request to the identified recipient using the recipient contact information; and
in response to receiving an enrollment reply from the identified recipient, distribute at least a portion of the donation amount to the identified recipient.

14. The system of claim 13, wherein the instructions that are configured to cause the processor to distribute the remaining portion of the prize share comprise instructions configured to cause the processor to:
for one or more candidate recipients, receive identifying information comprising:
a recipient identifier; and
recipient contact information;
apply a random process to select at least one donee from the one or more candidate recipients; and
distribute at least a portion of the second portion to the selected donee.

15. The system of claim 9, wherein one or more of the distributions uses a digital payment system.

16. The system of claim 9, wherein the instructions that are configured to cause the processor to distribute the remaining portion of the prize share comprise instructions that are configured to cause the processor to distribute some or all of the second portion to one or more recipients using a random selection process.

17. A system for processing a giving transaction, the system comprising:
a processor; and
a memory that stores programming instructions that are configured to cause the processor to:
receive, from user, a donation amount;
for one or more candidate recipients, receive identifying information comprising:
a recipient identifier; and
recipient contact information;
for each of the candidate recipients, identify a geographic region based on the associated identifying information;
receive demographic information associated with the identified geographic region;
determine a distance from a residence of the user to the geographic region;
select at least one donee from the one or more candidate recipients based on one or more factors, the one or more factors comprising the demographic information or the distance from the residence of the user; and
distribute some or all of the donation amount to the selected at least one donee using a digital payment system.

18. The system of claim 17, wherein the instructions that are configured to cause the processor to receive the identifying information comprise instructions that are configured to cause the processor to receive the identifying information from an online database of candidate recipients.

19. The system of claim 17, wherein the instructions that are configured to cause the processor to distribute some or all of the donation amount to the selected at least one donee comprise instructions configured to cause the processor to:
transmit an enrollment request to the selected at least one donee using the recipient contact information; and
in response to receiving an enrollment reply from the selected at least one donee, distribute some or all of the donation amount to the selected at least one donee.

20. The system of claim 17, wherein the instructions that are configured to cause the processor to select the at least one donee comprise instructions that are configured to cause the processor to apply random weights to the one or more factors to select the at least one donee.
